(19) United States
(12) Patent Application Publication
(10) Pub. No.: US 2004/0064381 A1
(43) Pub. Date: Apr. 1, 2004

(54) Method and system for supplying management and maintenance parts

(75) Inventors: Yuichiro Mizumachi, Tokai (JP); Kenji Yokose, Hitachi (JP); Tsuyoshi Aihara, Tokai (JP); Koichi Matsumoto, Hitachi (JP)

Correspondence Address: MATTINGLY, STANGER & MALUR, P.C., 1800 DIAGONAL ROAD, SUITE 370, ALEXANDRIA, VA, 22314, US

(73) Assignee: HITACHI, LTD.

(21) Appl. No.: 10/673,469

(22) Filed: Sep. 30, 2003

Related U.S. Application Data
(62) Division of application No. 09/985,014, filed on Nov. 1, 2001.

(30) Foreign Application Priority Data
Nov. 7, 2000 (JP) 2000-344224

(51) Int. Cl. G06F 17/60

(52) U.S. Cl. 705/27

(57) ABSTRACT

A method and system for supplying management and maintenance parts which enables earlier reception of orders of parts required for management and maintenance of products. A physical distribution management (logistics) server 3 is provided to connect users 6, a manufacturer 6, and cooperating manufacturers 9. The users 6 are connected to said logistic server 3 through Internet or the like. Said logistic server 3 contains a management and maintenance parts supply system 2 and a parts information (spare parts information) database which stores parts information required for management and maintenance of products. The users select required parts from said database and send information of the selected parts to said manufacturer.

### BACKGROUND OF THE INVENTION

1. Field of the Invention

The present invention relates to a method of supplying parts for management and maintenance of products.

2. Description of the Prior Art

A conventional method of supplying parts for management and maintenance of respective apparatus in a power plant or the like (or a method of supplying spare parts) comprises the steps listed below. Spare parts are defined into two for contracts with the users: mandatory spare parts which are essential to the plant and recommended spare parts. The mandatory spare parts are usually ordered by the user when a plant is ordered and contracted. They are delivered to the user before the plant is delivered. Contrarily, the recommended spare parts are ordered independently of the mandatory spare parts which are ordered at the entrance of a contract. They are delivered under a new contract. The conventional parts supplying method below is for recommended spare parts.

<Conventional Parts Supplying Method>

(1) After placing an order of a plant, the user makes an inquiry about recommended spare parts.

(2) Upon receiving the above inquiry, the plant manufacturer asks the cooperating manufacturers to select required parts for assurance of device reliability and to report their prices and expected delivery dates by written papers

(3) Usually, each component of the plant has many cooperating manufacturers all over the world and the recommended spare parts selected by the cooperating manufacturers are for each component of the plant. Therefore, the plant manufacturer selects the spare parts once more for assurance of reliability of the whole plant. For this purpose, the plant manufacturer must collect parts information from all cooperating manufacturers.

(4) When selecting spare parts, the plant manufacturer classifies them according to their degrees of significance (such as most significant components that may disable the plant if they get in trouble and components that cannot be delivered in a short time period).

(5) The plant manufacturer makes a listing of all recommended spare parts for the plant that are selected in (4), discusses the presented prices, and show them to the user.

(6) After receiving the list of recommended spare parts for the plant (made in (5)), the user selects spare parts that the user may require from the list and notifies the plant manufacturer of them.

(7) When receiving the list of spare parts from the user (6), the plant manufacturer places orders of the requested parts on the cooperating manufacturers.

Japanese non-examined Patent Publication No. 2000-214918 discloses a method of supplying spare parts directly by service persons in the plant site.

### SUMMARY OF THE INVENTION

As explained above, the conventional method of supplying spare parts for users of products comprises the steps of receiving inquiries from a user, collecting written information of the spare parts from the cooperating manufacturers, creating documents for the user, and so on. Therefore, a lot of time was spent before the manufacturer got an order of the spare parts from the user.

Further, the method disclosed in Japanese non-examined Patent Publication No. 2000-214918 aims to shorten a time period required for parts arrangement and increase operation efficiencies by enabling the service persons in the plant site to directly order spare parts. However, this method does not shorten a time period required before the manufacturer receives an order of spare parts (for management and maintenance) from the user.

An object of the present invention is to provide a method and a system for supplying spare parts for management and maintenance of products which shortens an order reception period.

To attain the above object, the present invention provides a method of supplying spare parts for management and maintenance of a product to users, which comprises a first step of supplying parts information related to said product to the user from a database which stores the parts information, a second step of receiving parts information which the user selected from parts information presented to said user, a third step of updating the parts information of the user-selected parts in said database, and a fourth step of informing the manufacturer of the selected parts information in said parts information.

Further, a system of supplying spare parts for management and maintenance of a product to users in accordance with the present invention comprises a server which connects user terminals and manufacturer's terminals for communication and a database which stores information pertaining to management and maintenance of said product which is at least one part of information about parts delivery periods, unit prices of parts, required quantities of parts, subtotals of parts prices and degrees of significance of parts; wherein said server has a function to output parts information from said database to said user terminals and said database has a function to update the parts information of the user-selected parts in said database and a function to output said user-selected parts information from said server to the manufacturer's terminals.

### BRIEF DESCRIPTION OF THE DRAWINGS

FIG. 1 is a hardware configuration which is the basis of this embodiment.

FIG. 2 is a flow of processing of information presented by this embodiment.

FIG. 3 is a processing flow of the system in accordance with this embodiment made by the user.

FIG. 4 is a processing flow of the system in accordance with this embodiment made by the manufacturer.

FIG. 5 is a log-in dialog box presented by this embodiment.

FIG. 6 is a menu window presented by this embodiment.

FIG. 7 is a window for user's selection of spare parts (before selection).

FIG. 8 is a window for user's selection of spare parts (after selection).

FIG. 9 is a window for reconfirmation of the content of the order (for the user).

FIG. 10 is a window for reconfirmation of the content of the order (for the manufacturer).

### DESCRIPTION OF SYMBOLS

1 Management and maintenance parts database

2 Management and maintenance parts supply system

3 Physical distribution (Logistics) server 3

4 Firewall

5 Internet

6 User

7 Manufacturer's Intranet

8 Manufacturer

9 Cooperating manufacturer

20 Manufacturer presented information

21 Lead time of parts (time period required befor delivery)

22 Unit price of part

23 Required quantity of parts

24 Subtotal of prices of each part

25 Degree of significance of parts

26 System code

27 Expiration date of part price

30 User presented information

31 Result of selection of spare parts

32 Grand total of part prices

101 User ID entry field

102 Password entry field

103 Log-I button

114 Order with Subcontractor Check button

115 Cancel button

120 Check box

121 Sort (Price) button

122 Sort (Lead time) button

123 Sort (Importance) button

124 Total Price display field

125 OK (Selection Complete) button

130 Order button

131 Total Purchase Price field

132 Return button

140 Total Booked Order Price field

141 Send Preliminary Order button

142 Return button

### DESCRIPTION OF PREFERRED EMBODIMENT OF THE INVENTION

The present invention will be described in further detail by way of embodiments with reference to the accompanying drawings. This embodiment assumes a case of exchanging information between a user and a manufacturer to supply spare parts of a power plant. However, it is to be understood that the present invention is not limited to a power plant. This invention is also applicable as far as the product requires spare parts.

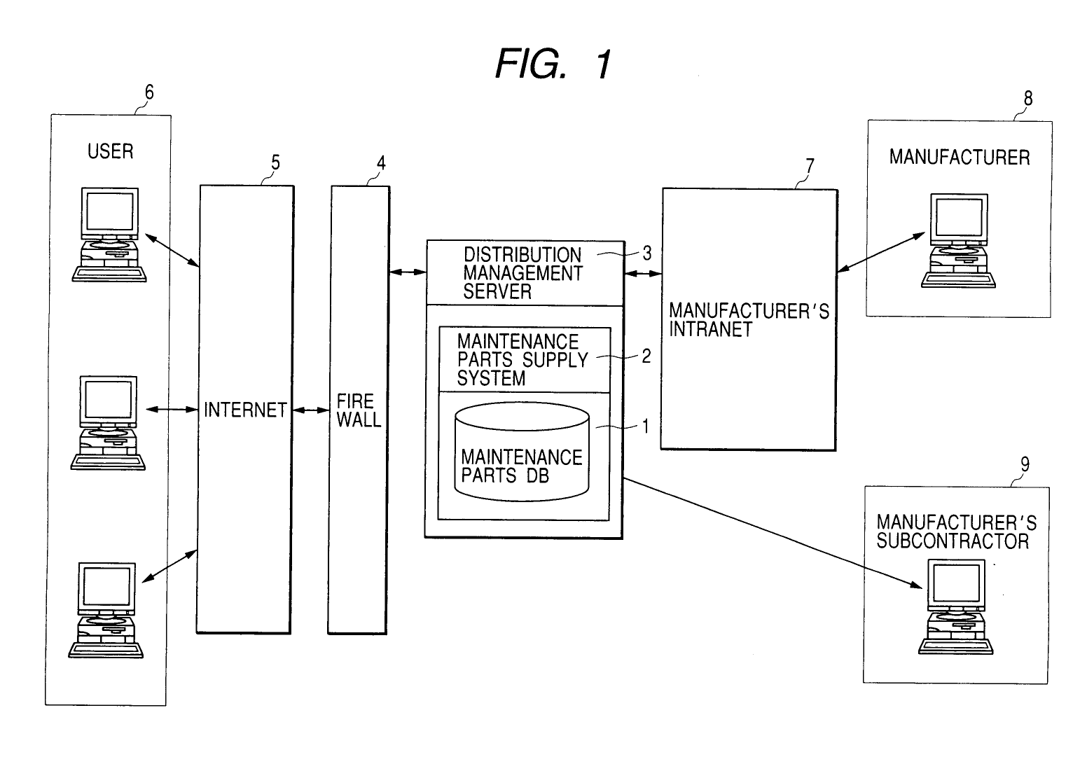

FIG. 1 shows a simplified configuration of hardware including a system of supplying management and maintenance spare parts for a power plant, which is the first embodiment of the present invention.

This embodiment has a management and maintenance parts database 1 which is the basis of the present invention as part of a management and maintenance parts supply system 2. Said database 1 and said parts supply system 2 are built in a physical distribution (logistics) server 3 which is established by the manufacturer. Said server 3 can be established by a company which is entrusted by the manufacturer 8 to manage spare parts (that is an offer of information of management and maintenance parts).

Firewall 4 is provided between the logistics server 3 and the user 6 to keep the server 3 safe from intentional attacks by third parties. The user can access the logistics server 3 through Internet 5 by registering the user for the administrator of the logistics server 3 in advance to get permission (a user ID) to use the server 3. With the user ID, the user can access the server 3 to use the management and maintenance parts supply system and the management and maintenance parts database 1. Substantially, the user 6 (a person in charge) accesses the logistics server 3 to use parts supply system 2 through Internet 5 from terminal equipment such as a personal computer placed in a booth in the power plant yard.

As the logistics server 3 is an open server established by the manufacturer, the manufacturer (person in charge) accesses the server 3 through the Intranet 7 of the manufacturer 8. However, the person in the cooperating manufacturer 9 is not allowed to access the logistics server but allowed singly to receive messages from the logistics server 3. It is also possible for the cooperating manufacturer 9 to access the logistics server 3 through Internet 5 to browse part of information that the server 3 stores including user-presented information 20 (to be explained later).

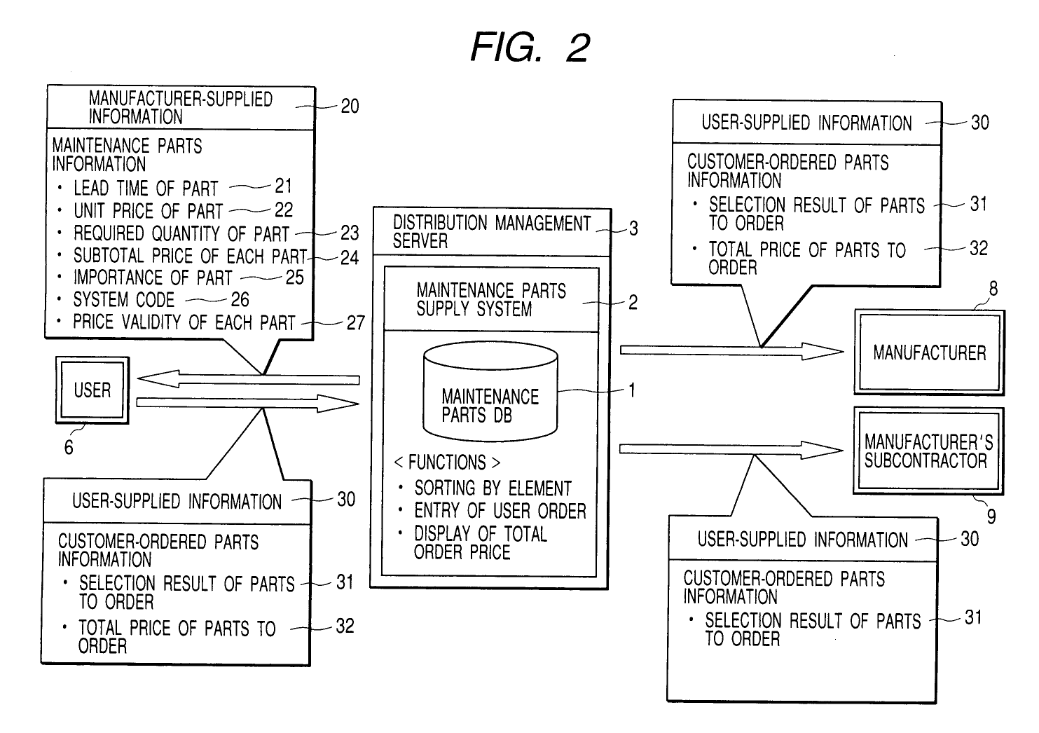

Referring to FIG. 2, below will be explained information items that are transferred between the user 6 and the manufacturer 8 through the management and maintenance parts supply system 2.

The management and maintenance parts database 1 stores information about parts required to manage and maintain the power plant. Said information contains a period 21 required before delivery, unit price 22, quantity 23, subtotal 24 (product of the unit price 22 by the quantity 23), degree of significance 25, system code of device or product using the part, and expiration date 27 of the price of each part.

The user 8 or manufacturer 8 (person in charge) can browse said pieces of information by accessing the logistics server 3 and starting the management and maintenance parts supply system 2. The user 6 (person in charge) browsing said pieces of information selects spare parts (management and maintenance parts) according to the user's maintenance/check schedule. As items to be considered for selection are a period 21 required before delivery of a part, subtotal 24 (product of the unit price 22 by the quantity 23), and degree of significance 25 of each part, the management and maintenance parts supply system 2 has a function to arrange information items by each element value or a plurality of element values.

Further the management and maintenance parts supply system 2 has check fields or user entry fields used by the user to select spare parts for ordering.

Furthermore, the management and maintenance parts supply system 2 has a function of representing total amounts of spare parts that are selected by the user 6 so that the user 6 may select spare parts on a limited budget while checking the total amounts of spare parts in combination.

According to the user's maintenance and check schedule, the user 6 (person in charge) selects spare parts in the information presented by the manufacturer and gives a check mark to each of the selected spare parts to indicate that the checked spare parts are to be ordered. After selecting and giving check marks to required spare parts, the user 6 (person in charge) clicks the ORDER button. With this, the selection of spare items by the user is sent as user presented information 30 to the management and maintenance parts supply system 2 through the logistics server 3. The user presented information 30 contains the result 31 of selection of spare parts for ordering by the user 6 and the total amount of the order 32. The logistics server 3 receives this user presented information 30 containing user's ordering information and sets it in the management and maintenance parts database DB1.

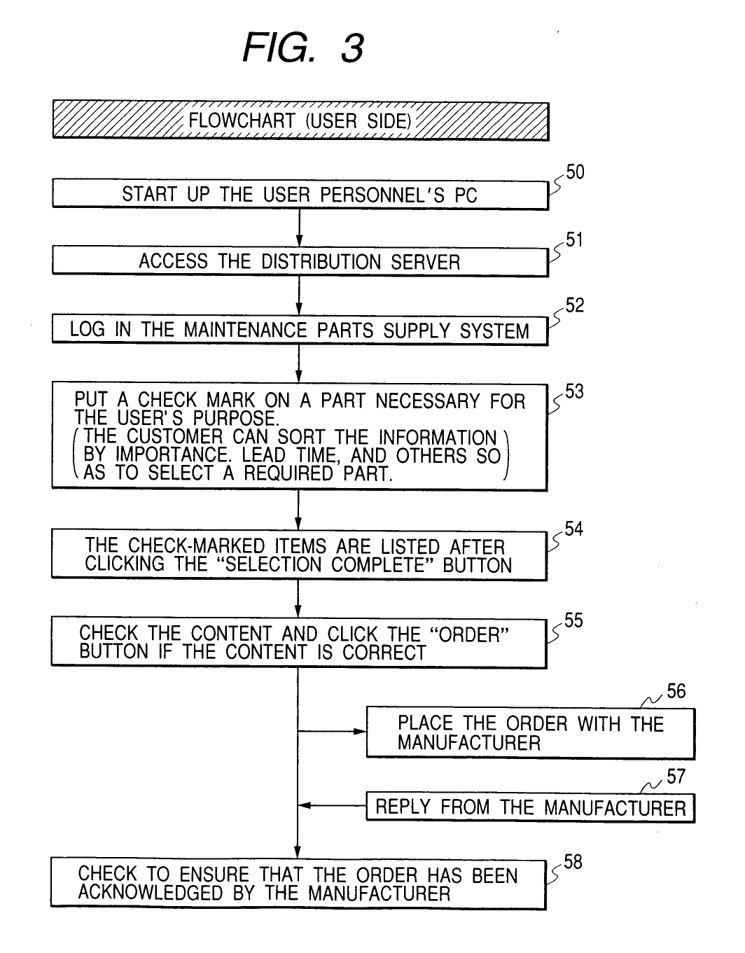

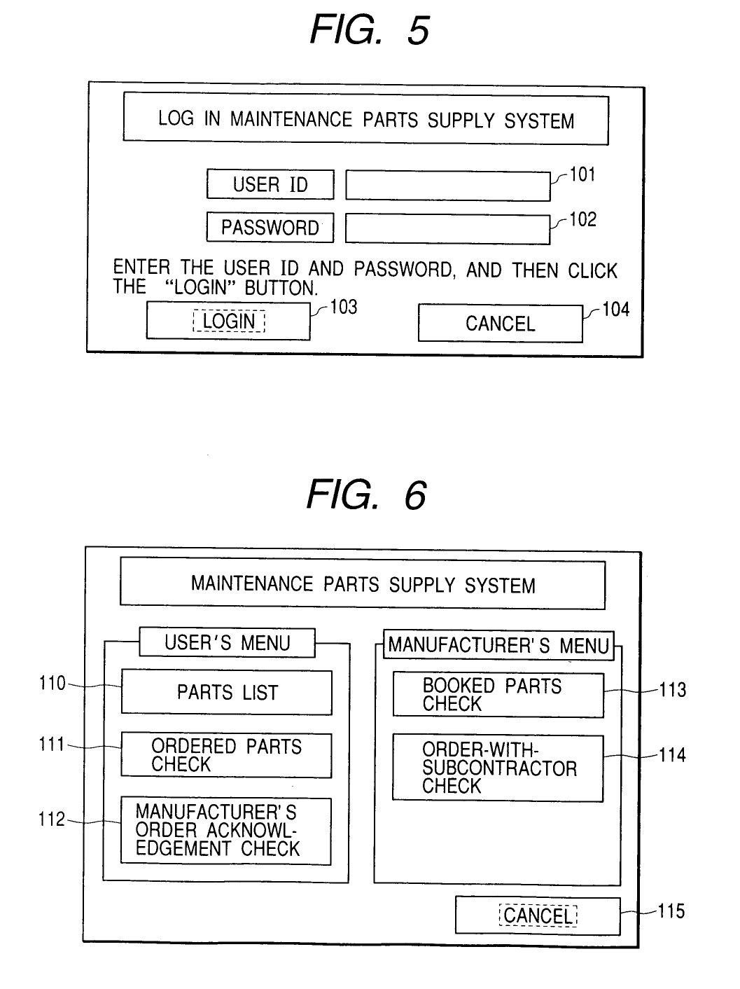

Referring to FIG. 3, process steps of the management and maintenance parts supply system 2 made by the user are explained together with windows which appear on the screen of the user's terminal (FIG. 5 to FIG. 9).

First, the user starts the user's personal computer PC and accesses the logistics server 3 through Internet 5. (Step 51). When accessing to the logistics server 3 succeeds, a log-in dialog box appears on-screen to allow the user to log in the management and maintenance parts supply system 2. The user 6 (person in charge) enters a user ID and a password which are given in advance. When the user ID and the password are correct, the user can log in the management and maintenance parts supply system 2. (Step 52)

FIG. 5 shows a dialog box to allow the user to long in the management and maintenance parts supply system 2. This window contains a user ID entry box 101 in which the user type the user ID, a password entry box 102 in which the user enters the password, a Login button 103 which enables the user to log in the management and maintenance parts supply system 2, and a Cancel button which cancels the log-in operation.

On said log-in window, the user 6 (person in charge) enters the user ID in the user ID entry box 101 and the password in the password entry box 102, make sure the user ID and the password are correct, and then clicks the Login button 103. With this, the user can log in the management and maintenance parts supply system 2.

When the user logs in the management and maintenance parts supply system 2, the Management And Maintenance Parts Supply System Menu window (to be explained later) appears. The user selects “Parts List” on the menu window. The List Of Spare Parts window appears for selection and ordering of spare parts. On this list window, the user selects desired spare parts and gives check marks to them. (Step 53)

FIG. 6 shows a display example of the Management And Maintenance Parts Supply System Menu window. This window comprises a user menu field for user's use only, a manufacturer's menu field for manufacturer's use only, and a Cancel button 115. Although this menu window contains both the user menu field and the manufacturer's menu field, they can be on different menu windows.

The user menu field for user's use only on this menu window contains a Parts List button 110 to call lists of management and maintenance parts (spare parts) which are prepared by the manufacturer, an Ordered Parts Check button 111 to call lists of spare parts that the user ordered for the manufacturer, and a Manufacturer's Order Acknowledgment Check button 112 to call a window to check whether the manufacturer received the order that the user placed. The manufacturer's menu field for manufacturer's use only on this menu window contains a Booked Parts Check button 113 to call a window for reconfirmation of spare parts by the manufacturer and an Order with Subcontractor Check button 114 to a call a window to check whether the manufacturer placed the order for the cooperating manufacturers. The management and maintenance parts supply system 2 has a System Protection function to prevent the user from using the buttons in the manufacturer's menu field and the manufacturer from using the buttons in the user's menu field.

On the Management And Maintenance Parts Supply System Menu window of FIG. 6, when ordering spare parts, the user clicks the Parts List button 110 on the menu window. A list of spare parts for selection and ordering appears on-screen.

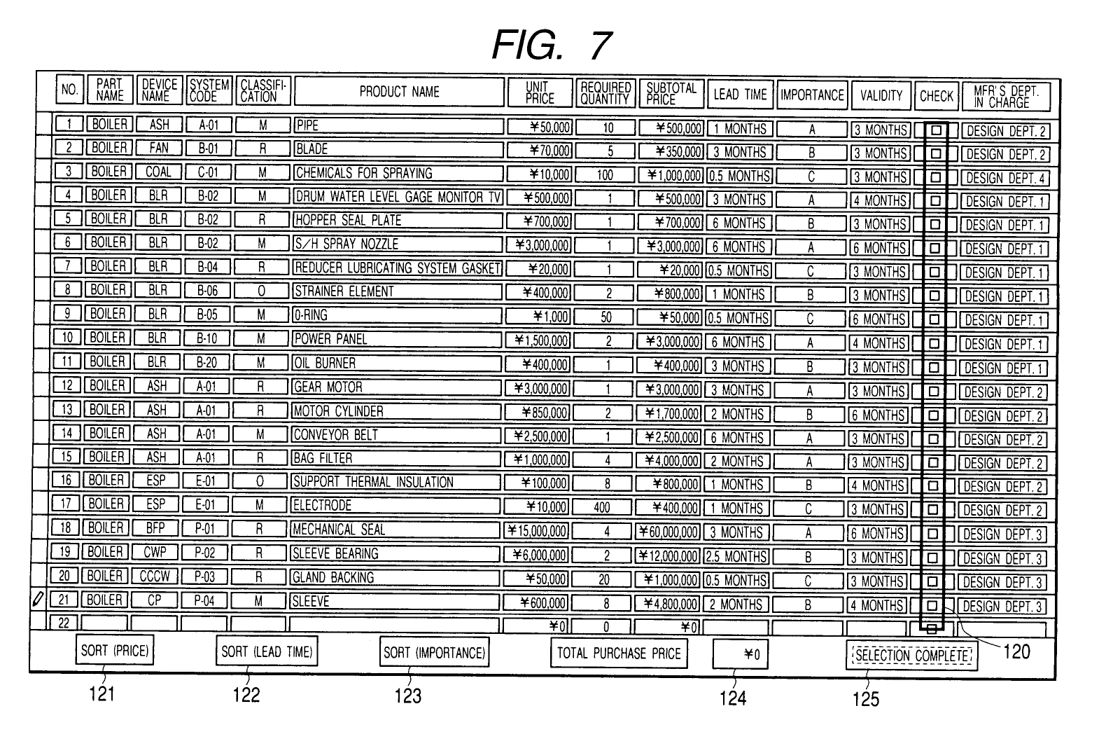

FIG. 7 shows an example of a list of spare parts for selection and ordering. For example, this list contains items such as List number, Product name, Device name, System code, Class, Part name, Unit price, Quantity, Subtotal, Lead time, Degree of significance, Price expiration, and Mfr's Dept in Charge. The content of this list is displayed according to information stored in the management and maintenance database 1.

Further, this list window contains a check box field 120 used to give a check mark to a selected part, a Sort (Price) button 121 to sort spare parts by a price, a Sort (Lead time) button 122 to sort spare parts by a period required before delivery, a Sort (Importance) button 123 to sort spare parts by a degree of significance, a Total Price display field 124 to display the total amount of prices of spare parts that the user selected, and an OK button 125 (Selection Complete) to set the selection and ordering.

The management and maintenance parts supply system 2 which is an embodiment of the present invention has a function to sort (search) the items in the spare part list by a selected element (as a key). To sort items in the spare parts list by a price, the user clicks the Sort (Price) button 121, the function sorts elements in the descending order of prices. To sort elements in the ascending order of prices, the user clicks the Sort (Price) button 121 again. Further, to cancel sorting, the user clicks the Sort (Price) button 121 once more. Similarly, to sort items by a period required before delivery or by a degree of significance, the user click the Sort (Lead time) button 122 or the Sort (Importance) button 123.

With these functions, the user 6 (person in charge) selects spare parts that the user want to purchase and gives a check mark to each of the selected items. When the user clicks a check box of an item (spare part), a check mark automatically appears in the check box. The user can assure what the user selected by this check mark. To cancel the selection of an item, the user has only to click the check box (having a check mark) once more. Initially the spare parts list has no check mark in the check boxes 120.

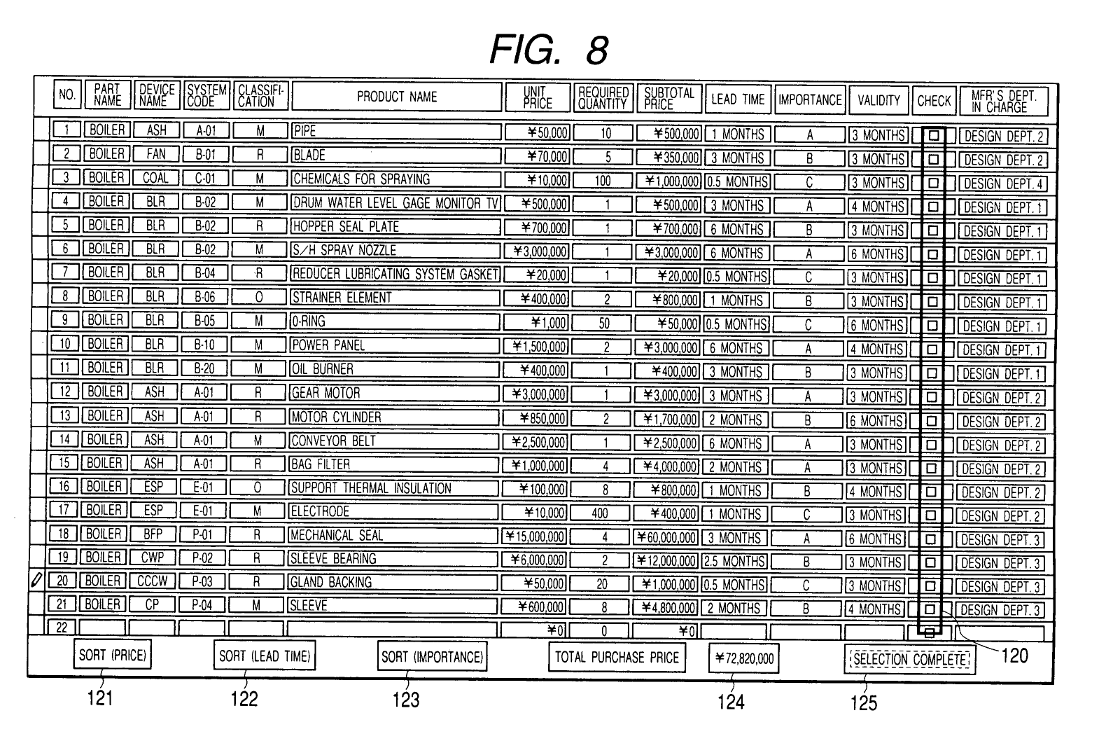

FIG. 8 shows a spare parts list in which the user 6 already selected and gave check marks to the selected elements. As seen from FIG. 8, when the user 6 (person in charge) selects a spare part and clicks its check box, a check mark appears in its check box and the Total Price display field 124 displays the total amount of prices of the spare parts to which the user gave a checkmark. With this, the user 6 can get the total amount of prices of the spare parts that the user wants to purchase at a glance and reduce or increase the kinds and quantities of spare list on the limited budget. In this way, the user can make appropriate selection and ordering of spare parts, considering the degrees of significance, availabilities, and prices of the spare parts. At the end of selection or required spare parts, the user clicks the OK button 125. With this, step 53 (for selection of required spare parts) is complete.

When the OK button is clicked, the Ordered Parts Check window appears for reconfirmation. This window shows a spare parts list in which the user 6 already selected and gave check marks to the check boxes of the selected elements. On this window, the user can reconfirm what the user selected and correct if necessary (for addition, deletion, and change of spare parts). (Step 54) When the content of the spare parts list that the user selected, the user clicks the Order button. (Step 55) With this, the selected spare parts are ordered to the manufacturer. (Step 56)

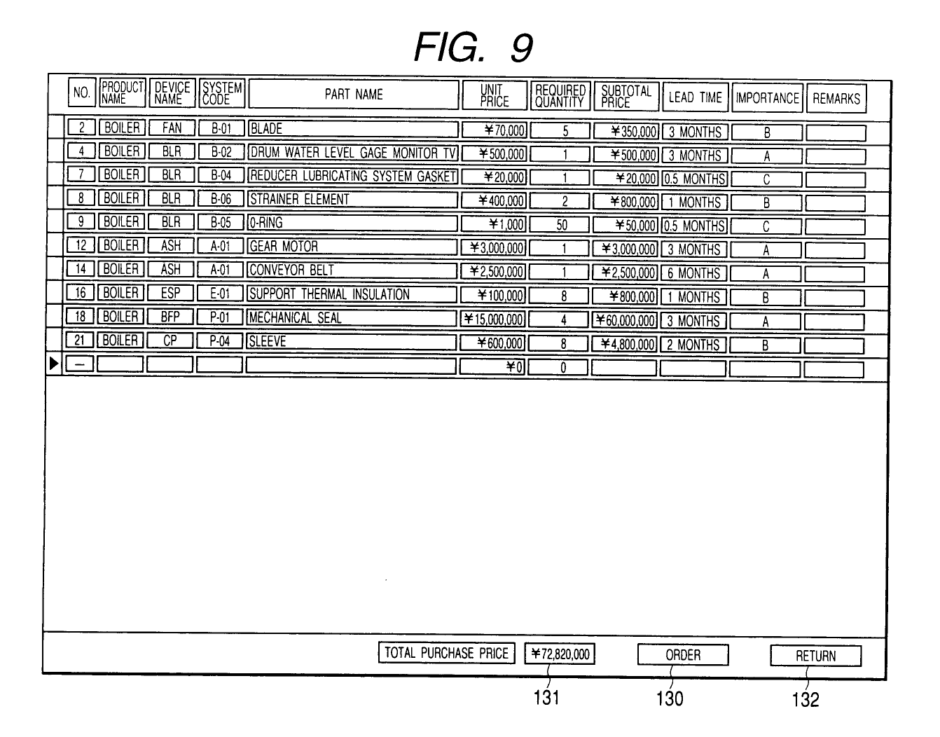

FIG. 9 shows a list of spare parts for reconfirmation before ordering. This list contains only spare parts to which the user 6 (person in charge) gave check marks. The grand total of their prices is given in the Total Purchase Price field 131. The user 6 (person in charge) can get the total amount of the order at a glance.

After making sure that the content of the parts list in Step 54 is correct, the user clicks the Order button 130. If the user has something to change in the parts list, the user clicks the Return button 132 on the reconfirmation window (FIG. 9) to return to the spare parts list (FIG. 8) and changes the setting in the check boxes 120.

After the user 6 places the order by clicking the Order button, the placement of the order is informed of to the manufacturer 8 (person in charge) by an electronic mail or the like. The management and maintenance parts supply system 2 is so designed to automatically create an electronic mail indicating that the user placed an order for the manufacturer when the user clicks the Order button and sends the mail to the manufacturer through the logistics server 3. The notification of the placement of the order can also be made by the other means for example by an order message through Intranet 7 of the manufacturer or by automatic facsimile transmission. Further, the information sent to the manufacturer 8 (person in charge) can contain a list of spare parts to be ordered (FIG. 9) or the like.

When receiving this order (sent in Step 56), the manufacturer answers to it by an electronic mail or the like to tell that the manufacturer received the order. (Step 57) When receiving the answer from the manufacturer, the user 6 can recognize that the order has been accepted by the manufacturer. (Step 58)

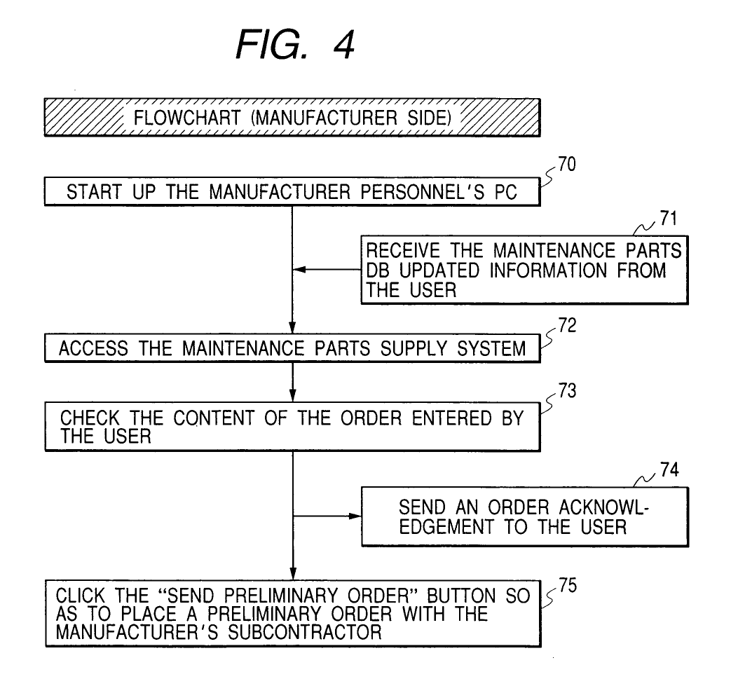

Referring to FIG. 4, below will be explained the process steps of the management and maintenance parts supply system 2 made by the manufacturer.

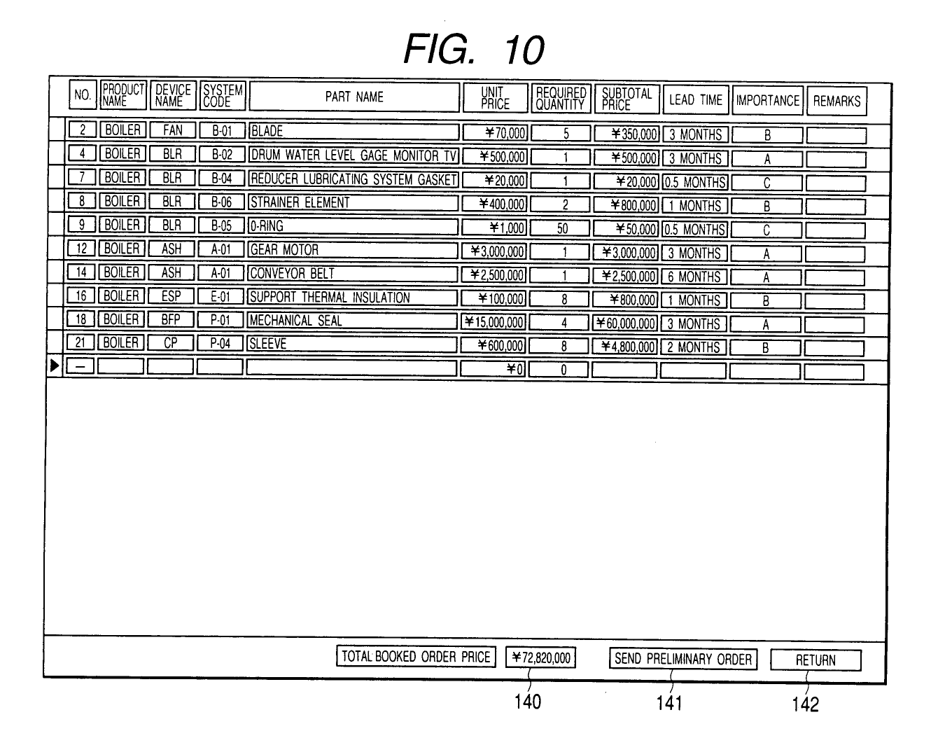

First, the manufacturer 8 (person in charge) starts its personal computer (Step 70) and receives an electronic mail (telling update of the content of the management and maintenance database) (Step 71). In response to this mail, the manufacturer 8 (person in charge) accesses the management and maintenance parts supply system 2 (Step 72) and clicks the Parts Check button 113 in the Manufacturer's menu field on the menu window (FIG. 6). With this, the manufacturer can go to the Order Check window (FIG. 10).

FIG. 10 shows an example of the Order Check window for the manufacturer. This window contains a Total Booked Order Price field 140, a Send Preliminary Order button 141, a Return button, and a list of ordered parts. The manufacturer 8 confirms the content of the order on this reconfirmation window (Step 73) and sends the acceptance of the order to the user by an electronic mail or the like. (Step 74) Then the manufacturer places orders (containing names and quantities of parts that the user 6 ordered) to the related cooperating manufacturers by electronic mails or by facsimile. In other words, the manufacturer clicks the Send Preliminary Order button 141. (Step 75) With this, the orders are sent from the manufacturer 8 to the cooperating manufacturers 9. The cooperating manufacturers can prepare the ordered parts quickly. This can shorten the time period required for ordering and delivering.

With this, the process steps of the management and maintenance parts supply system 2 made by the manufacturer are completed. Further, the menu window (FIG. 6) has an Ordered Parts Check button 111, a Manufacturer's Order Acknowledgment Check button 112, and an Order with Subcontractor Check button 114 to enable both the user 6 and the manufacturer 8 to check the processing status. When the user 6 clicks the Ordered Parts Check button 111, the list of ordered parts (FIG. 9) for reconfirmation appears on-screen. However, the “Order” button 130 is grayed on this window as the order is already placed. In other words, the user can check the content of a list of ordered spare parts and the value in the Total Purchase Price field 131 on this window. When the user clicks the Manufacturer's Order Acknowledgment Check button 112, a message “Orders Accepted” is displayed when the manufacturer already sent an “Order Accepted” message to the user (Step 74) or a message “Orders Not Accepted” is displayed when the manufacturer did not send an “Order Accepted” message to the user yet. Further, when the manufacturer clicks the Order with Subcontractor Check button 114, the “Ordered to Cooperating Manufacturers” message is displayed when the manufacturer already placed orders to the cooperating manufacturers (Step 75) or the “Not Ordered yet to Cooperating Manufacturers” message is displayed when the manufacturer did not place orders to the cooperating manufacturers yet. (Step 75) With these functions, the user and the manufacturer can reconfirm the contents of orders and how the orders are treated at a glance.

As already explained, the embodiment in accordance with the present invention enables the user to quickly order spare parts for management and maintenance of a purchased product such as a power plant at less ordering costs.

The present invention can provide a method and a system of supplying management and maintenance products which enables quick and early ordering.

What is claimed is

1. A method of supplying spare parts for management and maintenance of a product to users, comprising a first step of supplying parts information related to said product to the user from a database which stores the parts information, a second step of receiving parts information which the user selected from parts information presented to said user, a third step of updating the parts information of the user-selected parts in said database, and a fourth step of informing the manufacturer of the information of parts selected from said presented parts information.

2. A method of supplying spare parts for management and maintenance of a product to users, comprising a first step of transferring parts information of said product which is stored in a database from a server to a user terminal, a second step of causing said server to receive information of parts that said user selected from the parts information output to said user terminal, a third step of updating the parts information of the user-selected parts in said database, and a fourth step of outputting information of spare parts selected from presented parts information from said server to a manufacturer terminal or terminal of a cooperating manufacturer.

3. A method of supplying spare parts for management and maintenance of a product to users, comprising a first step of transferring parts information related to management and maintenance parts of said product which is stored in a database such as information containing periods of parts delivery or degrees of significance of parts from a server to a user terminal, a second step of causing said server to receive information of parts that said user selected from the parts information output to said user terminal, a third step of updating the parts information of the user-selected parts in said database, and a fourth step of outputting information of spare parts selected from presented parts information from said server to a manufacturer terminal or terminal of a cooperating manufacturer.

4. A method of supplying spare parts for management and maintenance of a product to users, comprising a first step of transferring parts information related to management and maintenance parts of said product which is stored in a database such as information containing one or more of a period required before delivery, unit price, quantity, subtotal, and degree of significance from a server to a user terminal, a second step of causing said server to receive information of parts that said user selected from the parts information output to said user terminal, a third step of outputting information of grand total of prices of the spare parts that said user selected to the user terminal, a fourth step of updating the parts information of the user-selected parts in said database, and a fifth step of outputting information of spare parts selected from presented parts information from said server to a manufacturer terminal or terminal of a cooperating manufacturer, and a fifth step.

5. A system of supplying spare parts for management and maintenance of a product to users comprising a server which connects user terminals and manufacturer's terminals for communication and a database which stores information pertaining to management and maintenance of said product which is at least one part of information about parts delivery periods, unit prices of parts, required quantities of parts, subtotals of parts prices and degrees of significance of parts; wherein said server has a function to output parts information from said database to said user terminals and said database has a function to update the parts information of the user-selected parts in said database and a function to output said user-selected parts information from said server to the manufacturer's terminals.
